(19) United States
(12) Patent Application Publication
(10) Pub. No.: US 2003/0015522 A1
(43) Pub. Date: Jan. 23, 2003

(54) Electrically activated adhesive system

(76) Inventors: Robert Parker, Bend, OR (US); Keith A. Papulski, Morrison, CO (US)

Correspondence Address: CHRISTIE, PARKER & HALE, LLP, 350 WEST COLORADO BOULEVARD, SUITE 500, PASADENA, CA, 91105, US

(21) Appl. No.: 10/170,560

(22) Filed: Jun. 13, 2002

Related U.S. Application Data
(60) Provisional application No. 60/297,851, filed on Jun. 13, 2001.

(51) Int. Cl. H05B 3/34

(52) U.S. Cl. 219/549; 219/543

(57) ABSTRACT

An electrically activated hot-melt adhesive tape for adhesively joining objects such as adjacent sections of carpet. The tape has a base which is typically paper, and an electrically conductive ink-like material is sprayed or printed on the base to form a thin central heating section, and thicker and hence lower-resistance conductive strips extending along opposite edges of the heating section. Scrim supporting beads of hot-melt adhesive is secured over the heating section. Alternatively, the heating section and conductive strips, which may be segmented, are applied to an underside of the base, and the scrim and adhesive beads to the opposite side of the base. An activating tool has extending electrodes which electrically contact the spaced-apart conductive strips to pass a current through the heating section to melt the adhesive beads in preparation for application to the objects to be joined.

### CROSS-REFERENCE TO RELATED APPLICATION

This application claims the benefit of U.S. Provisional Application No. 60/297,851 filed Jun. 13, 2001.

### BACKGROUND OF THE INVENTION

Heat-sensitive or so-called “hot melt” adhesive tapes have been used in a variety of bonding applications, and are especially well known in the carpet industry for seaming abutted sections of carpet. Carpet tape typically consists of a base layer of paper having on its upper surface a reinforcing open-weave fiber or fabric scrim in which are embedded beads or a solid layer of hot-melt adhesive. Conventional carpet tapes and associated heating irons are well known, and are described in, for example, U.S. Pat. Nos. 3,582,436, 3,927,295 and 4,536,244, the disclosures of which are incorporated herein by reference.

In use, conventional hot-melt carpet tape is centered between abutted carpet sections (or beneath the edge of a carpet section which abuts a wall), and a skilled installer then melts the adhesive by applying an electrically heated iron to the tape. The iron is slowly advanced beneath the raised carpet sections, and the carpet sections are depressed into the molten adhesive behind the advancing iron.

This conventional use of a hot iron for liquefying hot-melt adhesive has certain disadvantages. Considerable operator skill is required to advance the iron at a rate which properly melts the adhesive without overheating or burning either the tape base or the overlying carpet sections. Iron movement which is too rapid can result in melting of only the upper part of the adhesive bead or bed (typically about 0.060-inch in height), causing a weakened and imperfect bonding of carpet to substrate.

The melted adhesive begins to cool after the iron is advanced away, and the carpet sections must be immediately depressed into the adhesive to insure good bonding. Alignment and other errors are difficult and sometimes impossible to correct after the adhesive has cooled, and the carpet sections are secured in place. Some adhesive often clings to the hot surface of the iron, requiring time-consuming cleaning.

The system of this invention uses a tape with an electrically conductive resistive heating strip which is printed on the paper base of the tape. Reinforcing scrim and hot-melt adhesive are positioned above the heating strip. Opposite edges of the heating strip extend laterally beyond the scrim and adhesive to provide relatively low-resistance bus-bar-like conductors for contact with laterally spaced electrodes of a special hand-held contactor of slender profile which replaces the conventional carpet-seaming hot iron. Further advantages and details of this new system are given in the following detailed description.

### SUMMARY OF THE INVENTION

The adhesive system of this invention includes an electrically activated adhesive tape having a base which is typically paper, and a thin, flexible layer of electrically conductive material positioned centrally and extending along the base to form a heating section. A pair of spaced-apart conductive strips of lower resistence than the heating section are positioned on the base on opposite sides of and in connection with the heating section. A heat-activated adhesive extends along the tape in alignment with the heating section. A flow of current between the conductive strips and through the central heating section heats the adhesive to a molten state for application to objects to be joined such as adjacent strips of carpet.

### DESCRIPTION OF THE DRAWINGS

FIG. 1 is a plan view of a resistively heated carpet tape;

FIG. 2 is an enlarged cross-sectional view (not to scale) of the tape on line 2-2 of FIG. 1, and before placement of scrim and adhesive;

FIG. 3 is a perspective view of a hand-held adhesive-activating contactor;

FIG. 4 is a plan view, partly broken away, of the contactor positioned on the tape beneath adjoining carpet sections;

FIG. 5 is an enlarged cross-sectional view (not to scale) of an alternative embodiment of the tape.

FIG. 6 is a top view of a second and presently preferred embodiment of a carpet tape according to the invention;

FIG. 7 is a bottom view of the second embodiment;

FIG. 8 is a sectional end view on line 8-8 of FIG. 6;

FIG. 9 is a perspective view of a portion of a base of a modified hand-held contactor useful with the second embodiment; and

FIG. 10 is a perspective view of the modified contactor as engaged with a tape of the second embodiment.

### DETAILED DESCRIPTION OF THE INVENTION

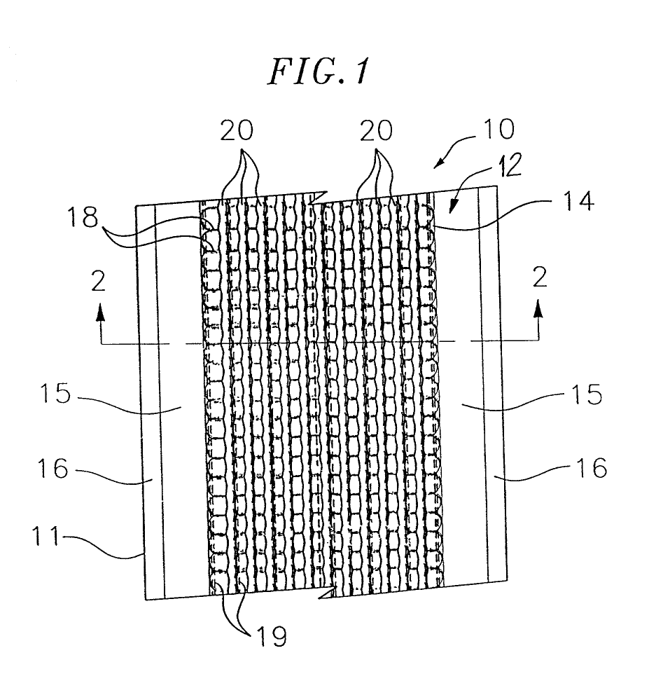

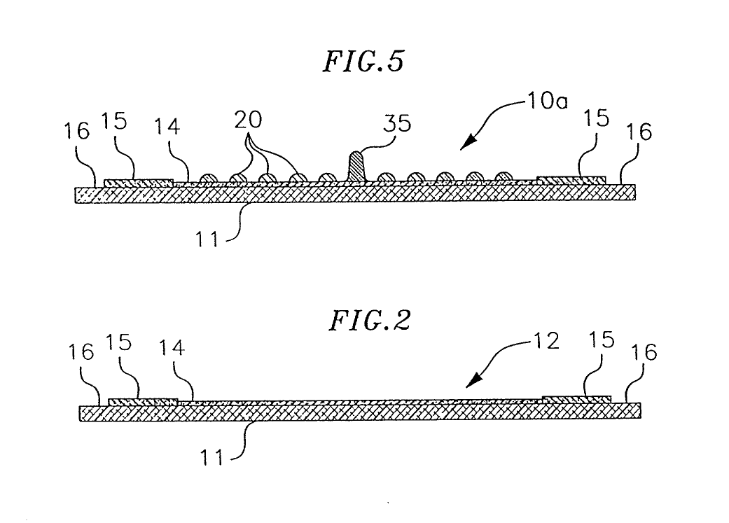

FIGS. 1 and 2 show an electrically activated hot-melt tape 10 according to the invention. The tape has a paper base 11 (plastic films may also be used) on which is sprayed or printed a variable-thickness layer or coating 12 of an electrically conductive material. This material is typically an ink-like liquid dispersion of finely divided graphite powder in a thermoplastic resin which rapidly air dries to form a flexible conductive coating having a predictable electrical resistance.

Dispersions suitable for spraying or printing to form coating 12 are available from Acheson Colloids Company in Port Huron, Mich., under the product descriptions Electrodag 109 and SS24600, both of which have a sheet resistivity of about 40 ohms/square at a wet coating thickness of 0.001-inch. Resistivity can be diminished to as low as 0.1 ohm/square by intermixing with a more highly conductive silver material available from Acheson Colloids as Electrodag 415.

As shown in the cross-sectional view of FIG. 2, the coating is formed with a thin (typically 0.35-mil wet thickness) central heating section 14, along the opposite lateral edges of which are formed thicker (about 1-mil wet thickness) and hence more conductive strips 15. Alternatively, strips 15 may be printed from the aforementioned conductive silver ink, or may be formed of metal foil. The thinner central coating results in a sheet resistivity of about 80 to 90 ohms/square for heating section 14. The coating extends continuously along the entire length of the tape which is provided in roll form.

In a typical configuration, the width of central heating section 14 is about 2¼ inches, and conductive strips 15 are each about ½ inch wide. Outer unprinted sections 16 of paper base 11 are about ⅜ inch wide, resulting in a typical overall width of 4 inches for tape 10.

Conventional woven-fiber scrim 18 (FIG. 1) with longitudinally extending lines of stitching 19 is placed over heating section 14, and molten adhesive beads 20 are then applied over and through the scrim. The cooled adhesive secures the scrim and embedded adhesive beads to the heating section. The scrim strengthens the tape, and provides a seating surface for the adhesive beads. The scrim can also be bonded or sewn to the paper prior to application of the thermoplastic adhesive.

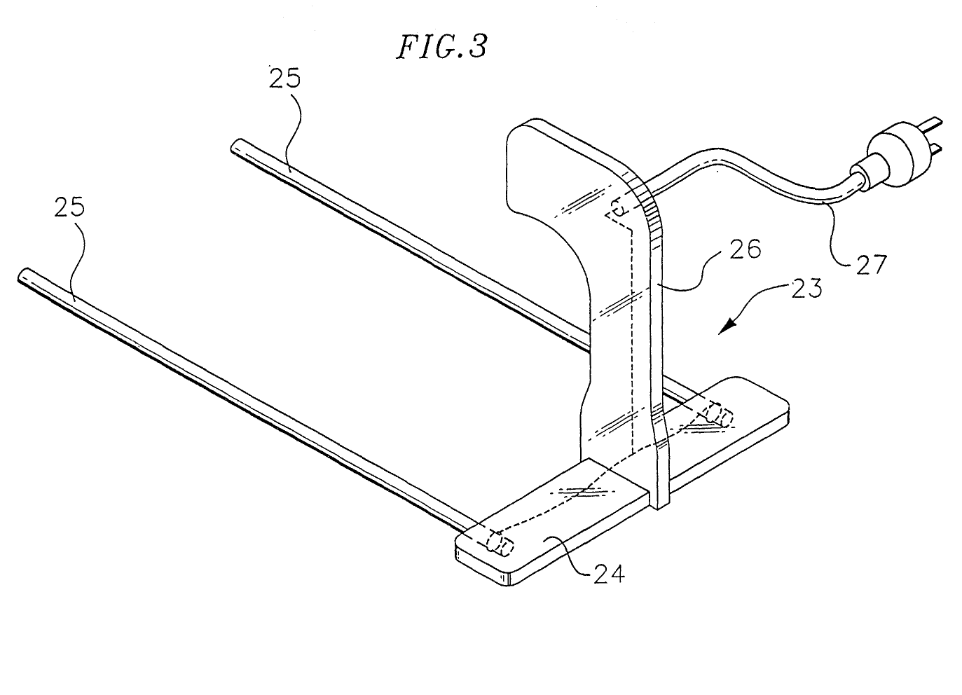

A hand-held contactor or activating tool 23 is shown in FIG. 3, and the tool has a base 24 (slightly wider than tape 10) from which extend a pair of electrodes 25 which are laterally spaced apart to overlie and contact conductive strips 15 when the tool is centered on the tape. A slender handle 26 extends upwardly from the center of the base, and a cable 27 secured to the handle provides an electrical connection to the electrodes from an external power supply (not shown) which is preferably of adjustable voltage.

Base 24 and handle 26 are made of a nonconductive material such as plastic. Electrodes 25 are made from copper or another conductive material, and may be rod shaped, or in the form of flat sled-like strips. The length and construction of the electrodes can be made either longer or shorter to suit specific bonding applications, and a typical length is about 10 inches.

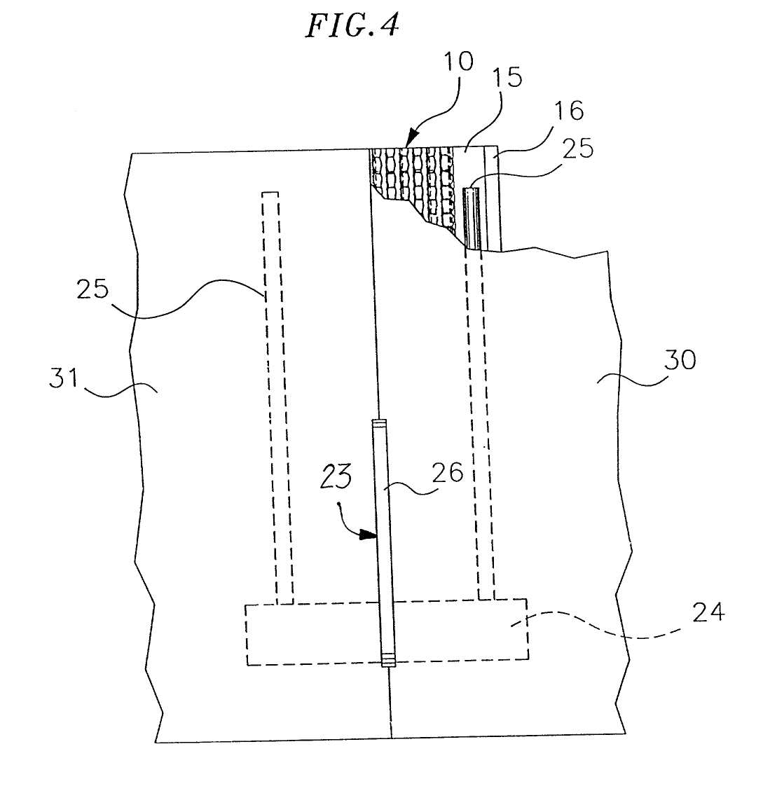

FIG. 4 shows the system in use in a carpet-seaming application. Abutting carpet sections 30 and 31 are lifted away from each other to enable positioning of tool 23 over tape 10 which is centered beneath the carpet sections, and with electrodes 25 resting against conductive strips 15. The carpet sections are then returned to a flattened abutting position, with only a slight separation for handle 26.

With the tool power supply activated to apply a voltage of say 48 volts between the electrodes, current flow through the tape heating section causes sufficient heating to melt the adhesive beads between the electrodes in about 15 to 20 seconds. The tool is then advanced along the tape to an adjacent unheated section, and the carpet sections are pressed into the molten adhesive which quickly cools to achieve a bonding of carpet to tape.

A significant advantage of the new system is an ability to reenter the bonded carpet sections from the top to remelt the tape adhesive if necessary to correct any misalignment of the sections or other errors which may have occurred. These kinds of corrections are usually not possible with hot-melt carpet tapes which have been activated by a conventional hot iron. Thin needle-like electrodes may be used on tool 23 to initiate the reentry from the top surface of the seamed carpet.

Heating of the tape is primarily confined to heating section 14 due to the thin cross section of this section which results in a relatively high electrical resistance. The overlying adhesive beads provide a heat sink which enables good heat transfer from the heating section. Conductive strips 15 have a much lower resistance due to the greater thickness of these strips, and only a desirably slight temperature increase occurs outside of the heating section.

The electrical resistance of the printed conductive material can be determined from the equation:

$$R = {ϱ}_{1} \frac{l}{A} = {ϱ}_{1} \frac{l}{tw}$$

where Q₁ is the resistivity of the conductive material, l is the length of the material segment, A is the cross-sectional area of the segment, and t and w are the thickness and width of the segment.

The heating density (watts per square inch) of a conductive segment is determined by the following equation:

$$\frac{W atts}{{inch}^{2}} = \frac{{V}^{2}}{{L}^{2} {ϱ}_{2}}$$

where V is the voltage applied across the segment by the tool electrodes, L is the lateral spacing of the electrodes, and Q₂ is the sheet resistivity of a segment having equal length and width, segment thickness being incorporated in the value of sheet resistivity. For example, for an applied voltage of 45 volts, electrode spacing of 2¼ inches, and resistivity of 90 ohms per square, the heating density is 4.5 watts per square inch.

Many variations of the basic system are both possible and anticipated. For example, tape 10 may be provided with adhesive beads on both sides to enable bonding of the tape to the overlying carpet sections and an underlying carpet pad, floor, or other substrate. If desired, an adhesive of lower melting point (as compared to the upper-surface adhesive) can be used on the tape undersurface to compensate for heat transferred to the underlying substrate. Though the tapes already tested are formed with conventional hot-melt carpet adhesive, various kinds of thermosetting plastic materials (in some cases with an epoxy coating to prevent chemical attack) can also be used.

Another alternative form of a tape 10A is shown in FIG. 5, and is similar to tape 10, with the exception that a raised center adhesive bead 35 is provided. The raised bead provides automatic centering of the tape beneath the abutting carpet sections. A notch is provided in the undersurface of tool base 24 to receive the raised central bead which assists in assuring proper alignment of the tool. Importantly, the molten raised center bead coats the abutting edges of the carpet sections to provide adhesive bonding of the edges. The raised center bead may be co-extruded from adhesive having a somewhat lower melting point (as compared to the adjacent non-central beads) to insure uniform melting of all of the beads.

It is possible to vary several parameters of tape 10 to provide heating appropriate to a given application. The resistivity of the sprayed or printed conductive ink can be adjusted to provide desired resistance heating which can be constant or variable across the tape width. A similar control can be provided by varying the thickness of the heating section across the tape width. Power-supply voltage can also be adjusted to vary heating time and achieved temperature.

A second and presently preferred embodiment of an electrically activated hot-melt tape 40 is shown in FIGS. 6-8. As explained below, tape 40 uses segmented heating sections on the underside of the tape to minimize the formation of localized hot spots which might cause delamination of adhesive and scrim from the paper base.

A top view of tape 40 in FIG. 6 is generally similar to FIG. 1, with the exception that the flexible conductive coating as already described is on the underside of the tape. FIG. 6 thus shows the upper surface of tape 40 as having a paper base 42, the central portion of which is covered with scrim 43 and beads 44 of hot-melt adhesive. Opposed edge sections 45 of paper base 42 are exposed and not covered by scrim and adhesive.

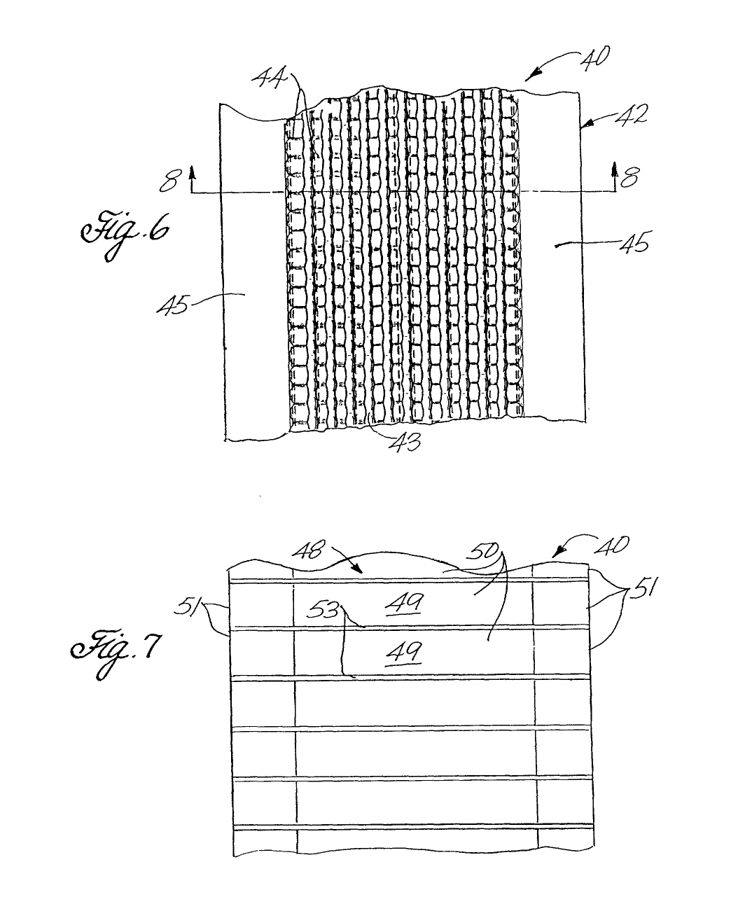

A segmented conductive coating 48 on the underside of tape 40 is shown in the bottom view of FIG. 7. Coating 48 comprises a series of segmented lateral conductive bands 49 each having a central thin heating section 50, with thicker and lower-resistance conductive strips 51 along opposite edges of the heating section as described above.

Conductive bands 49 preferably have a length (extending in the longitudinal direction of the tape) of about one-fifth the width of heating section 50. The strips are separated by nonconductive gaps 53 (typically about 0.005 inch in the longitudinal direction of the tape) formed by uncoated portions of the underside of paper base 42.

Segmentation of the conductive strips minimizes the formation of excessive current density between the advancing ends of electrodes of an activating tool, and which could cause excessive localized heating leading to possible delamination of the scrim and adhesive beads. Heat from the underside heating sections transfers efficiently through the paper base to melt the adhesive beads without overheating.

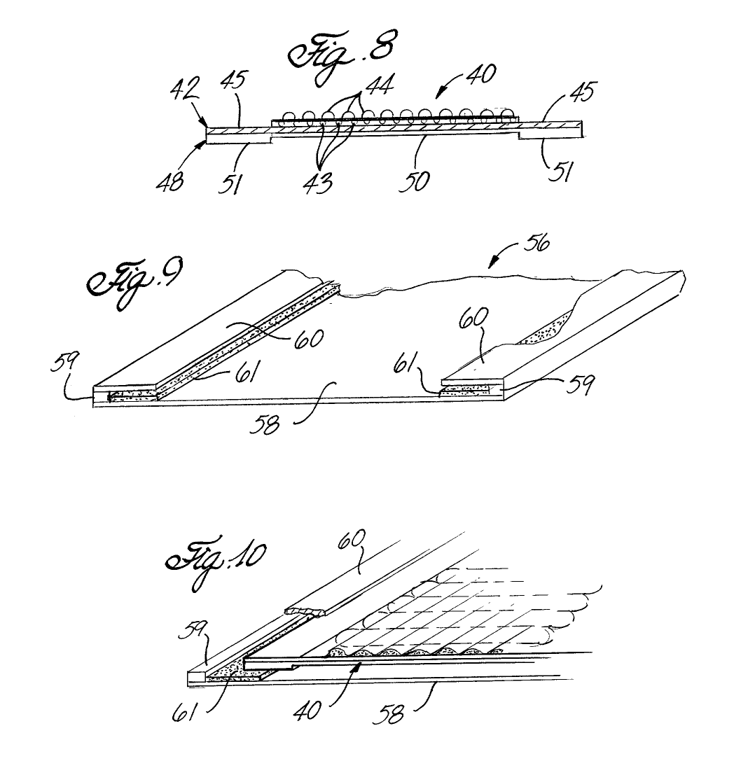

FIG. 9 shows a base 56 of an alternative activating tool 57 having a slender handle (not shown) and attached cable just as described above with reference to tool 23. Base 56 has a flat rectangular bottom plate 58 having elongated spacers 59 secured thereto, the spacers extending along opposite side edges of the bottom plate. Slender upper plates 60 are secured to upper surfaces of the spacers, and extend inwardly toward each other over the bottom plate. A pair of spaced-apart electrodes 61 (thin copper strips are suitable) are secured to the bottom plate beneath the upper plates, and the electrodes are coupled to the tool cable (not shown) for connection to a power supply.

Spacers 59 are spaced apart slightly more than the overall width of tape 40 so the tape can be slidably received within the base between bottom and upper plates. The upper plates are flexible, and are spaced from the bottom plate slightly less than the thickness of tape 40 in the area of conductive strips 51 to exert a slight compressive force against the inserted tape, and thereby to insure good electrical contact between electrodes 61 and strips 51. The inner edges of the upper plates are sufficiently spaced apart to avoid overlying the adhesive beads on the tape.

Base 56 (upper and bottom plates, and spacers) is preferably made of a flexible composite resin material such as fiber-reinforced polystyrene or polycarbonate. Use of such a flexible material enables the upper plates to be lifted slightly during fitting of the tool over tape 40, and also enables bending of the base to simplify withdrawal of the tool adjacent a wall or similar surface.

Tools 23 and 57 may also be provided with an infrared or similar heat sensor to provide an electrical signal to the system power supply when a desired temperature has been reached. This signal can command a voltage reduction to a level (e.g., one volt) which is sufficient to keep the adhesive in a molten state until the user is ready to shift the tool to a new position. An adjustable voltage-reducing transformer may also be mounted on the tool handle to eliminate need for a separate power supply.

Though the system has been described in terms of use in carpet bonding, it is equally useful in other applications, including bonding of rigid materials to a substrate. For example, objects such as mirrors can quickly and easily be secured to a wall using the electrically activated hot-melt tape of the system.

1. An electrically activated adhesive tape, comprising:
a thin, elongated, flexible base;
a thin and flexible layer of electrically conductive material positioned centrally on and extending along the base to form a central heating section, the conductive material having a first electrical resistance;
a pair of spaced-apart conductive strips on the base and extending along opposite sides of the central heating section, the conductive strips having a second resistance which is lower than the first resistance; and
a heat-activated adhesive extending along the tape in alignment with the central heating section;
whereby a flow of electrical current between the conductive strips and through the central heating section heats the adhesive to a molten state for application to objects to be joined.

2. The tape of claim 1 in which the adhesive is positioned over and in contact with the central heating section.

3. The tape of claim 1 in which the adhesive and central heating section are aligned on opposite sides of the base.

4. The tape of claim 1 in which the electrically conductive material is applied to the base as a liquid dispersion of a graphite powder in a carrier of thermoplastic resin, and subsequently dried.

5. The tape of claim 1 in which the central heating section and conductive strips are integrally formed, the heating section being substantially thinner than the conductive strips.

6. The tape of claim 1 which is configured for adhesively joining adjacent sections of carpet.

7. The tape of claim 1, and further comprising an activating tool having a base, a pair of spaced apart electrodes extending from the base for contacting the conductive strips, means for connecting the electrodes to a power source, and a handle extending from the base.
